(19) United States
(12) Patent Application Publication
(10) Pub. No.: US 2003/0122085 A1
(43) Pub. Date: Jul. 3, 2003

(54) Field ionization ion source

(76) Inventors: Gerhard Stengl, Wernberg (AT); Hans Loschner, Wien (AT); Elmar Platzgummer, Wien (AT)

Correspondence Address: Thomas R. Vigil, c/o Welsh & Katz, Ltd., 120 South Riverside Plaza, Chicago, IL, 60606, US

(21) Appl. No.: 10/034,728

(22) Filed: Dec. 27, 2001

(51) Int. Cl. H01J 27/00

(52) U.S. Cl. 250/423 F; 250/423 R

(57) ABSTRACT

A field-ionization source, comprising array of emitter electrodes (31) and counter electrodes (32) positioned at a distance from the base (P1) of the emitter electrodes. The emitter electrodes, ending in emitter tips (61), extend from their bases towards corresponding openings (62) of the counter electrodes and are adapted to be connected to a positive electric high voltage with respect to the counter electrodes. At the emitter tips (61), gas species provided from a source substance are field-ionized by means of the high voltage and ions thus produced are accelerated through the openings (61, 41). A distribution system (43, S2) is provided to distribute said source substance from a supply to the space (S1) around the emitter tips.

### FIELD OF THE INVENTION AND DESCRIPTION OF PRIOR ART

The present invention relates to field-ionization ion sources. In particular, the invention relates to a field-ionization source which comprises an array of emitter electrodes and counter electrode means positioned at a distance from the base of the emitter electrodes; within an emitter space, the emitter electrodes extend from their respective bases towards the counter electrode means and end in emitter tips, which each are located near to a corresponding opening formed in said counter electrode means.

Ion sources are used in various technical applications. One of these is ion-beam lithography, which involves patterning of a layer of radiation-sensitive material on a substrate by means of an ion beam or a multitude of ion beams projected onto the substrate. In particular with ion-beam lithography, the main requirements posed on an ion source are high brightness, i.e., a high beam current emitted form the source within a narrow angle, and low spread of ion energy. In field-ionization ion sources, the ionization of the atoms or molecules from a source gas is done by a high electrical field (in contrast to, e.g., thermal ionization). An overview about field-ionization ion sources suitable in the field of ion-beam lithography is given by B. M. Siegel, in Section IV of “Ion-Beam Lithography”, Chapter 5, of ‘VLSI Electronics Microstructure Science’, Vol. 16, Eds. N. G. Einspruch and R. K. Watts, Academic Press, Orlando 1987, pp. 173-195. Two main types are of major interest, namely, liquid-metal ion (LMI) sources and gaseous field ionization sources.

In an LMI source a liquid of a metal or alloy having a relatively low melting temperature flows on a tip, made of a material such as tungsten, serving as an ion-emitting anode. An electric voltage of several kV is applied to the tip by means of an extractor system. This voltage produces an electrical field of several 10¹⁰ V/m at the tip apex, causing field ion emission from the liquid surface of the tip. With LMI sources, ions of various metallic elements with high current intensities can be produced; however, the energy spread of 5 to 40 eV is relatively large, giving rise to large chromatic aberration when the beam is focused in an electrostatic ion-optical system.

Gaseous field ion sources (GFISs) are based on principles known from the field ion microscope (FIM) and the field electron emission microscope (FEEM). in a FEEM, a negative voltage is applied to a tip, and electrons tunnel into vacuum from the metal of the tip with the applied electric field and imaged onto, e.g., a screen. In a FIM, a positive electric voltage is applied, and image formation is initiated by ionization of a gas or vapor within a few Ångströms (10⁻¹⁰ m) of the specimen surface under the influence of the electric field. The field ionized atoms or molecules are then accelerated by the electric field. Prerequisites for operation of a GFIS (or a FIM or FEEM) are low temperatures, preferably temperatures of liquid nitrogen or below, and ultrahigh vacuum (UHV).

A helium field-ion source is discussed in detail by K. Horiuchi et al., in Microcircuit Engineering 84, eds. A. Heuberger and H. Beneking, Academic Press, London, 1985, pp. 365-372. In a UHV chamber, held at a background pressure of 10⁻⁶Pa, a tungsten emitter tip is mounted on a sapphire block and surrounded by a stainless steel envelope, which simultaneously serves as a thermal shield, in order to cool the tip to a temperature of about 15 K, and as an ion extractor (cathode) through an aperture made in the envelope next to the emitter tip. Helium gas which served as source gas is fed into the emitter space surrounded by the envelope by differential pumping; optimal operation of the source was found to occur at about 5 Pa, yielding an angular ion current of up to 2 μA/sr at 18 kV.

In the presentation of Siegel (op.cit.), a hydrogen (H₂⁺) field-ion source is discussed, able to produce an angular ion current of 20 μA/sr at 6 kV and a pressure of about 10⁻³Pa at the space around the emitter tip.

While the GFIS sources can produce ion beams of considerable brightness, construction and instrumentation of this type of ion sources proved to be demanding, since the emitter tip, usually made of W or Ir, must be cooled to cryogenic temperatures and isolated from heat loads, simultaneously electrically insulated so it can be floated to the voltage to which the ion beam is to be accelerated, and the whole system must be kept under UHV condition so the emitter tip can be thermally processed—a necessary conditioning treatment to “sharpen” the tip before operation as an ionization source—and its operation not affected by contamination.

An electron field-emitter array is described by T. Debski et. al., in “Micromachining and Electrical Characterization of Gated Field Emitter Arrays”, presented at the Micro- and Nano-Engineering Conference (MNE 2000) in Jena (Germany), Sep. 18-21, 2000, t.b.p. in Microelectronic Engineering. According to that document, a plurality of field-emitter cells was formed on a single-crystal silicon wafer in a regular rectangular array. Each cell of this array comprises a hollow formed in to the surface of the silicon substrate, with a sharp tip located in the hollow and extending from the bottom of the hollow. The gate electrode—formed as a TiW metal film on the level of the initial substrate surface—covers part of the hollow, leaving wide side openings through which the under-etching of the hollow into the substrate has been done, and has a central opening in which the apex of the tip is located. The distance of these very high aspect ratio gated field emission tips was realized to be as low as 175 μm. For non-gated field emission tips (tip height: 45 μm, tip radius: <10 nm) a distance as low as 10 μm has been realized as shown in “High Aspect Ratio Silicon Tips Field Emitter Array” by “Ivo W. Rangelow et.al., presented at the Micro and Nano-Engineering Conference (MNE 2000) in Jena (Germany), Sep. 18-21, 2000, t.b.p. in Microelectronic Engineering. In the publication, “Design, Fabrication, and Characterization of Field Emission Device” by M. R. Rakhshandehroo et.al., Solid State Laboratory, Univ. of Michigan (www.eecs.umich.edu/˜pang/projects/mr.html), the successful fabrication of emitter tips with sidewall angle of 80°, 11 μm height 2.2 μm basewidth, emitter tip radias of 8 nm with a packing density of 4×10⁶ tips/cm² is reported.

It should be noted that the gate electrodes in the arrays in the publications of T. Debski's et.al. and M. R. Rakhshandehroo et.al. are meant for controlling the electron emission from the tip by locally modifying the electric field around the tip apices, but not for applying the electric high voltages needed for field emission or field ionization operation; this would be impossible for lack of appropriate insulation against the substrate body. Moreover, if these arrays (which is actually designed for electron emission) were to be used as a field ion source, a sufficient and sufficiently homogenous supply with a source gas would be difficult and is expected to interfere with the ion beams to be produced.

### SUMMARY OF THE INVENTION

It is an object of the present invention to provide a field ion source characterized by a high current density as well as high quality of the virtual source of the ion beam or multiple ion beam produced.

This aim is met by an field-ionization source of the type as mentioned in the beginning wherein, according to the invention,

the field-ionization source further comprises a distribution system connectable to a supply for a source substance and being adapted to distribute said source substance towards the emitter tips in the emitter space,

the emitter electrodes are adapted to be connected to a positive electric high voltage with respect to the corresponding counter electrode means, and

the emitter tips are adapted to ionize gas species provided from the source substance by means of said high voltage and accelerate ions thus produced through said corresponding openings in said counter electrode means.

Advantageous aspects of the present invention are the two-dimensional extendibility of the ion source, which can in principle cover the area of a whole 30 mm wafer, as well as a high degree of brightness of the beams. Thus, a broad ion beam is offered which, at the same time, has a very low virtual source size, namely, in the order of the dimension of the apex of a single emitter tip. It should be noted that the ion sources according to the invention may also be used as electron emission sources, by inverting the voltages applied; in contrast, with known electron emissions sources the application of an inverted voltage alone, in order to obtain an ion-emitting source, would be problematic due to the lack of proper insulation.

Preferably, the emitter electrodes are arranged in a two-dimensional periodic arrangement and the counter electrode means comprises a two-dimensional arrangement of openings corresponding to said emitter electrode array, said two arrangements surrounding the emitter space of the emitter electrodes. The two-dimensional periodic arrangements may, in particular, be arrays positioned parallel to each other, and may further be planar arrays, or curved arrays having concentric curvatures.

According to a further advantageous aspect of the invention, at least the tips of the emitter electrodes preferably consist of non-metallic material, including material from the group of semiconductors. Furthermore, the emitter electrodes may comprise a cover layer of chemically inert material having an electronic structure suitable for field ionization.

In order to obtain a simple and reliable supply of the source gas, the distribution system may be adapted to be operated by means of differential pumping of a gas used as source substance from the supply through the emitter space towards a pumped-off space.

In order to achieve a high ion yield, it is useful if the emitter space, including the emitter electrodes, is adapted to be cooled to a low, favorably to a cryogenic, temperature, which is feasible using a cryogenic liquid. In order to simplify the realization of the cooling and source gas supply systems, the cooling of the emitter space may be done by means of the source substance being supplied as coolant.

In order to obtain proper insulation of the emitter and counter electrodes, it is suitable if the base of the emitter electrodes is separated from the counter electrode means by a vacuum gap. For this, a wafer chuck system is suitably employed in order to precisely hold and position the emitter electrodes and the counter electrode and simultaneously ensure electrical insulation.

Advantageously, the ion source according to the invention may further comprise a multi-beam electrostatic lens arrangement, which is realized by the apertures of the counter electrode means and/or electrode provided in additional electrode means (so-called ‘flies eyes’ lens), being adapted to focus the ions emitted and accelerated through the counter electrode means, e.g., into an array of highly parallel ion beams.

### BRIEF DESCRIPTION OF THE DRAWINGS

In the following, the present invention is described in more detail with reference to the drawings, which show:

FIG. 1 a perspective view of a field ionization source of an embodiment of the invention;

FIG. 2 the source of FIG. 1 mounted in a source station setup, in a longitudinal section with source gas reservoir;

FIG. 3 details of the source of FIG. 1, showing cut-away views of two field ionization cells in a longitudinal sectional detail —FIG. 3a—and a top view detail—FIG. 3b—respectively.

FIG. 4 a cross-section of the source of FIG. 1, showing schematics of the kinematic mount and nanometer positioning system of the component constituting the source.

### DETAILED DESCRIPTION OF THE INVENTION

In the following a preferred embodiment of the invention is presented and discussed in detail, namely, a multi-tip gaseous field ion-ionization. It is understood that the invention is not restricted to the embodiment shown; rather, the embodiment shown illustrates one way to realize the invention.

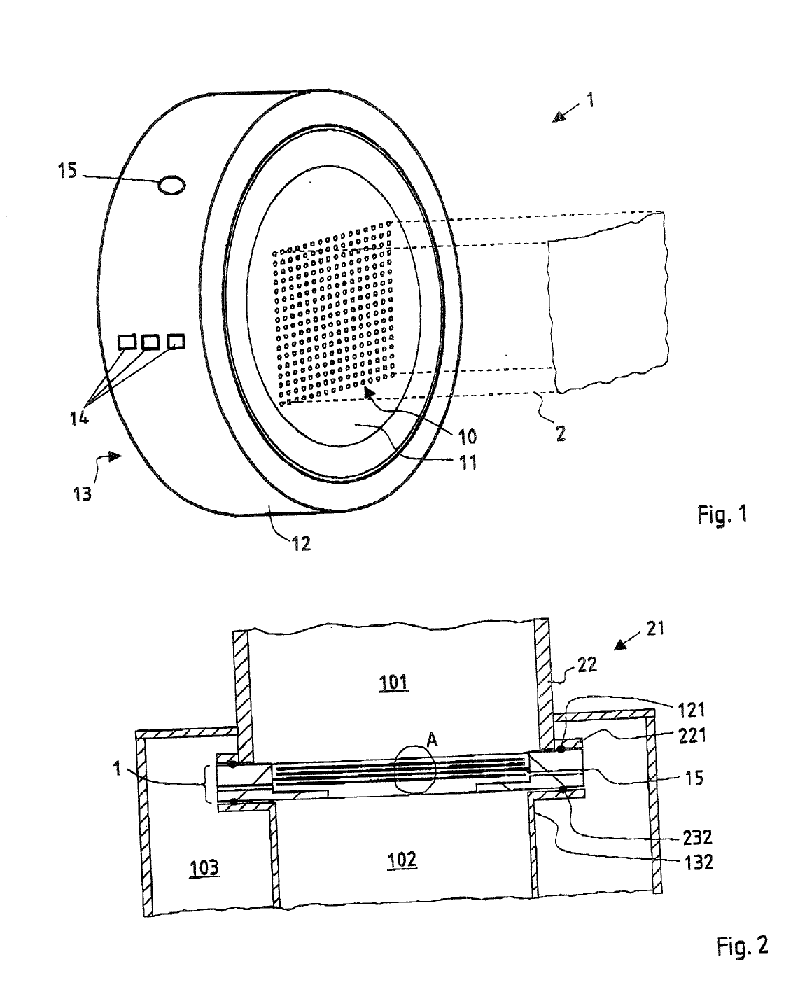

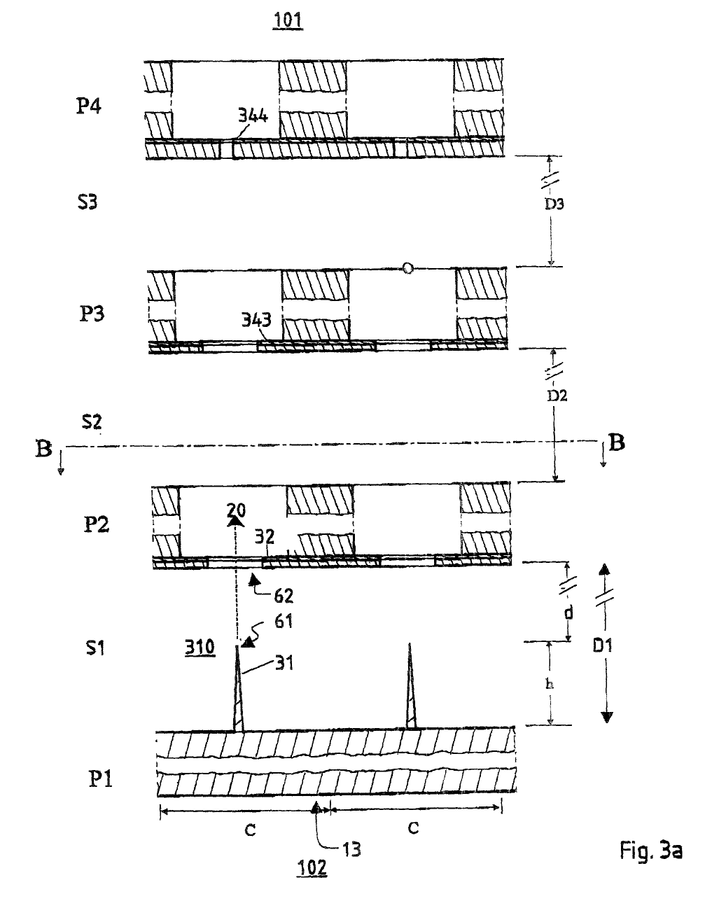

FIG. 1 shows a multi-tip ion source 1 in a perspective view onto the “front” side of the source. As the source 1 is made from a set of semiconductor wafers held within a carrier device as further discussed below, its size corresponds roughly to that of a silicon wafer as used in semiconductor technology. The source 1 comprises an array 10 of field ion-ionization sources, which can be recognized from the array of openings on the front side 11 of the source. Upon operation of the source 1, the source array 10 produces an array of parallel ion beamlets 2 emitted into the high vacuum or UHV space 101 (FIG. 2) to which the front side of the source 1 is connected. The electrical supply for the operation of the source, in particular the high voltage and control voltages for the fine positioning elements, is done by means of a set of electrical contacts 14 which are, e.g., positioned on the side surfaces of the source 1.

FIG. 2 shows the source 1 (depicted in FIG. 2 only in outlines) as mounted in a source station setup 21. Within the housing 22 of the station 21, the source 1 is held in position by means of connecting pieces 121, 132 and respective O-ring fittings 221, 232. As already mentioned, the front side of the source 1 is connected to a high vacuum or UHV space 101 into which the ion beam is emitted. To the top of FIG. 2, an ion-beam apparatus, not shown in the drawings, such as an ion-beam lithography device would be situated. At its side walls 12 the source 1 is in contact with a source gas reservoir 103 containing, e.g., hydrogen or helium gas, which simultaneously may serve as coolant and supply of the source substance from which the emitted ions are produced. The back side 13 of the source is connected to a pumped-off vacuum chamber 102; in the embodiment shown, the vacuum chamber 102 is contained in a holder means 132 which also serves as a connecting piece for the source 1 and as a separator means from the source gas reservoir 103. By differential pumping of the source gas from the reservoir space 103 through supply openings 15 into the source 1 and from there towards the vacuum chamber 102, the field ion-ionization source array 10 is supplied with the source gas from which the ion species of the beam 2 are produced.

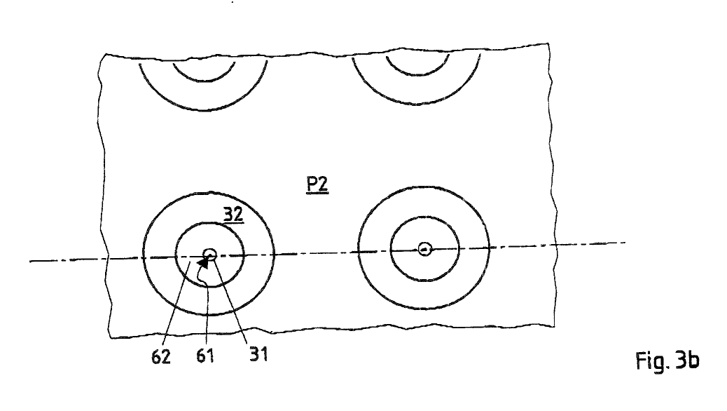

FIG. 3a shows a detail (as indicated by the contour A in FIG. 2) of a longitudinal section through the source 1. A corresponding sectional view detail along the line B-B in FIG. 3a is given in FIG. 3b.

The ion source contains an array of individual sources C, which are referred to hereinafter as ‘source cells’ or short ‘cells’. In the embodiment shown, the cells C are arranged in a rectangular array, wherein the cells are alloted square areas of same size (FIG. 3b). The side length of the cells, equivalent to the distance of the tips of neighboring cells, can be e.g. 50 μm corresponding to 4×10⁴ tips/cm². As noted above, this is well within the state of the art as it is feasible is to produce up to 4×10⁶ tips/cm².

Each source cell comprises an emitter electrode realized as a needle 31 and a ring-shaped counter electrode 32 (also referred to as extraction electrode). The emitter needle 31 is positioned in an emitter space 310. The base of the needles 31 is realized by a base plate P1 at the source back side 13. The counter electrode 32 is part of another plate P2 which is parallel to the base plate P1. The plates P1, P2 are held at a defined distance D1 to each other, thus defining an emitter space S1 between these plates which is composed of the already-mentioned emitter spaces 310. The needles 31 preferably have a high aspect ratio—i.e., ratio of height over the half width at the base—of at least 3:1, preferably 5:1 or greater. The needles should extend sufficiently from the base plate so the field between the counter electrode and base plate does not limit the field enhancement at the apex of the tip electrode.

In each cell C, the emitter electrode 31 and the corresponding counter electrode 32 are positioned so as to be coaxial; that is, the tip 61 of the emitter electrode is located on the central axis of the circular opening 62 of the counter electrode. Reasonably, the distance D1 between the base of the electrode tip and the associated opening of the counter electrode should be large enough to prevent discharge. In the embodiment shown, this distance D1 is the distance between the two plates P1, P2 bearing the emitter and counter electrodes 31, 32, respectively. Assuming as typical values a gas pressure of 1 Pa and a potential difference of 10 kV, the tip-to-opening distance d will be around 1.0 mm, and the height h of the tips, depending on their aspect ratio, about 100 μm. Thus, the ratio of the tip height h to the distance d of the apex 61 from the counter electrode opening 62 is here chosen as h:d=1:10, and the distance D1=1100 μm. In general the tip height h depends on the overall shape of the needle, the radius of the apex and the electrostatic potential applied.

It should be noted that in practice, the tip-to-opening distance d is fixed by the focal length of the aperture lens, which follows from the potential difference when going through the aperture. The focal strength of an aperture lens is independent of its diameter as long as the potentials on each side remains unchanged. The diameter of the opening 62 is of no influence to the focusing performance of an aperture lens. However, the diameter should be chosen such that no significant sputtering occurs during ion extraction (here for example 25 μm).

In the embodiment shown, a high precision coaxial arrangement, e.g. below 25 nm lateral misalignment of the emitter and the counter electrodes 31, 32, facilitates the control of the emission angle of the individual sources, which results in a divergence angle below 50 μrad of individual ion beams. The tolerances for the vertical (i.e., along the distance d) positions of the tips with respect to the openings for focusing each beam is about 5 μm, assuming a beam aperture diameter of 10 μm. This value is well above the expected curvature of a high quality wafer material (within the cross section area of the source, e.g. 2 inch), which generally limits the planarity of the tip plane.

As noted above, micro-machining methods to produce dense arrays of substantially identical needle-shaped tips having a large aspect ratio and contact those tip arrays electrically, are known from the present state of the art. In a recent publication “Fabrication and Electrical Characterization of High Aspect Ratio Silicon Field Emitter Arrays”, by I. W. Rangelow et.al., presented at the International Vacuum Microelectronics Conference (IVMC 2000), China, August 2000, t.b.p. in J. Vac. Sci. Technol, the production of arrays of DLC (diamond-like Carbon) covered silicon tips is discussed. Through DLC coating of the Si tips a long term emission stability could be achieved. Again it should be noted, however, that the arrays produced using the method of Rangelow et al. are intended for electron field emission, but not for field ionization which is not considered in that work.

As will be clear from the above, the emitter electrode is preferably produced from a material, in particular a semiconductor material such as silicon, which can be structured by micro-structuring methods well known from the state of art. A suitable coating, e.g. DLC or single crystal metal coatings, of these Si tips improves FIA performance. Of course, also other tip materials like metal tips, such a molybdenum or platinum tips could be used as well. It should be remarked that preferably d-metals such as for example Pt, have shown enhanced activity for field ionization. The optimization of the electronic structure has to be addressed in view of the gas species used, as it is the difference of the binding energy of the electron in the gas atom and the Fermi energy of the tip that is a measure for the tunneling resistance at given field strength. Thus, tip materials and/or dopants can be chosen in correspondence with the gas species used to promote a “most resonant” tunneling process.

Another tip coating material which may prove very effective with the invention, are carbon nanotubes which inherently have profitable properties such as a high mechanical stability, an excellent thermal conductivity and a near-to-perfect aspect ratio.

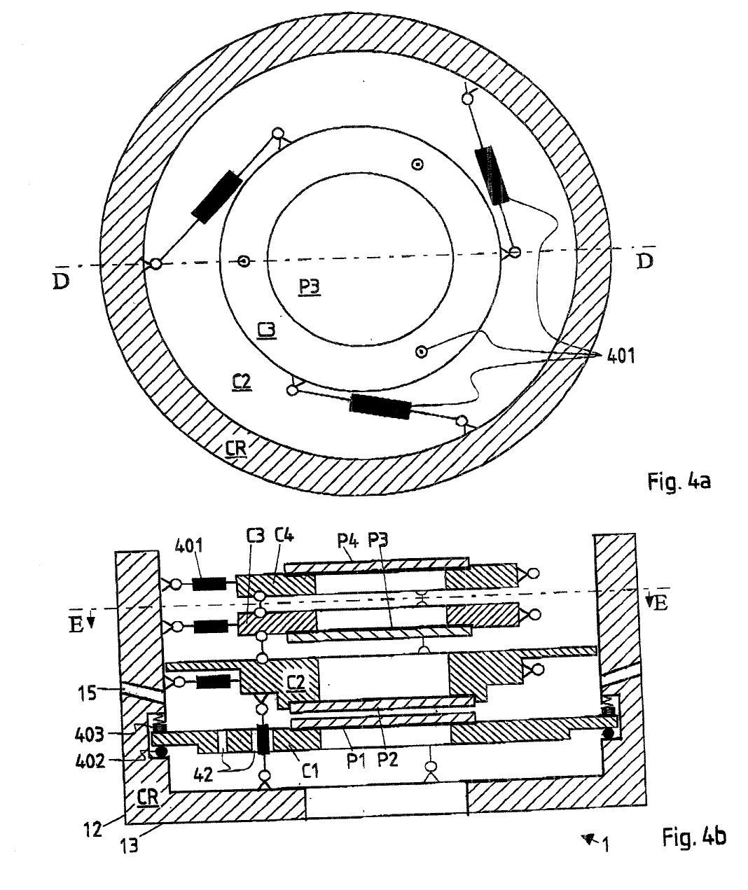

As already mentioned, the coolant applied to the source sides 12 for cooling purposes of the ion source and, in particular, the emitter electrodes 31, also serves as a source for the ionization process. The coolant is pumped differentially through supply openings 15 in the housing of the source into the emitter space S1, thereby establishing the gas pressure needed for the field ion-ionization process, and from the emitter space S1 through openings 42 (FIG. 4) leading to the vacuum chamber 102.

In the embodiment shown, the source space S1 below the counter electrode plate P2 is differentially pumped with respect to the target space 101 into which the ion beams are emitted. The two plates P1, P2 bearing the emitter electrodes 31 and the extraction electrodes (counter electrodes) 32 constitute an ion extraction arrangement which represents the main part of the source 1. In the preferred embodiment shown here, the plates constituting the source 1 are positioned at defined distances to each other by means of suitable positioning means, such as chuck means as discussed further below. Furthermore, one or more front plates P3, P4 may be provided. The front plates P3, P4 preferably comprises electrodes and/or deflectors 343, 344 in order to adjust and/or focus the ion beam 20 emitted from the ion extraction system. Thus, in an apparatus based on the invention additional front plates may also be used for beam-shaping and imaging purposes like in a multi-beam optics.

In the embodiment shown, the distance D2 between the first front plate P3 and the counter electrode plate P2 is 2.0 mm; the distance D3 between the two font plates P3, P4 is 10.0 mm. It is understood that these distances form only one set among possible and suitable solutions for arrangement of an ion optical system. The distances D1, D2, D3 between the plates P1-P4 are not shown to size in FIG. 3a.

It is a further advantage of the present invention that by virtue of the small ion energy spread of about 0.5 eV, the chromatic error of optical imaging is very low. Therefore, it is sufficient to use a condenser optics as simple as that of an aperture lens. In comparison, with known focused ion beam systems of LMI sources, due to the rather high energy spread of up to 10 eV, aberrations due to the condenser system are significant. For this reason known condenser lens systems of LMI sources contain three or more electrodes to achieve a resolution below 100 nm.

For a single emitter tip 61, an ion beam current is expected in the range of 10 pA-100 pA (see K. Horiuchi et al.) inside a 10 mrad divergence half angle. This is about the acceptable angular region to achieve sub 100 nm resolution by either focussing the beam directly to a substrate, or use subsequent imaging means. In an array 10 with source cells of 50 μm spacing, this corresponds to current densities of 0.4 μA/cm² to 4 μA/cm², respectively. There should be the possibility to decrease the tip spacing to 20 μm, thus enhancing the possible current density to 2.5 μA/cm² to 25 μA/cm². Moreover, by reversing voltages the present field ionization source can be used easily as an electron emission source as well. This mode also offers the possibility to determine the properties of the emitter tip, such as the tip radius, by means of a log U vs. log I measurement, in a so-called Fowler-Nordheim plot.

By virtue of the electrical insulation of the emitter tips, the ion source according to the invention is characterized by thermal and electric losses which are very low, since the losses are mainly due to parasitic currents flowing between the emitter and counter electrodes. In comparison to other ion sources, the invention advantageously offers the possibility to control and/or adjust the beam within very short time intervals by means of variation of the electric potential in the extracting region.

The physical effect underlying the ion source according to the invention is, as already mentioned, tunneling of an electron from a neutral gas particle to the solid surface under the effect of the high electric field applied. In this context, it is important that, due to the tunneling barrier, tunneling will only occur very near to the apex—within about 0.4 nm—so it is possible to produce a well-defined, high-quality ion beam. The extractable ion current depends on the supply function and the ionization probability of the source gas, both depending in a complex manner on various factors involving intrinsic properties of the gas atoms (or molecules), for example the electric polarizability, the temperature of the tip, the tip radius, the tip material, and etc.

The process of field ionization near the apex requires an electric field strength F between 20 and 50 V/nm (a factor of about 10 higher than typically for electron emission), which is related to the tip radius and the applied electrostatic potential by the approximate formula F=U/5r; the electrostatic potential U ranging between 2 and 20 kV. To achieve the necessary field enhancement near the tip at preferably low voltages, the tip radius needs to be in a range around 10 nm. Although a tensile stress as little as that of pure Al or Be suffices to keep the apex intact under the applied field, and a resistivity of the tip material as high as 5·10⁵ Ωcm has been sufficiently low in FIM applications (in order to ensure that the electric field does not reach too far inside the bulk material of the tip), it is obvious that the surface, i.e. the tip-vacuum interface, has to be optimized in order to produce maximum intensity and stability. The optimization concerns a) chemical and tensile stability of the interface, b) surface conductivity, and c) controlled modification of the electronic structure. The first two aspects a) and b) are realized, for instance, by a coating with a suitable material, such as the so-called diamond like carbon (DLC) coating, DLC coatings were already used to stabilize field emitter electrodes for example by Rangelow et al. (op.cit.). In order to improve the conductivity of an ultra-thin DLC film, its electrical resistance can be decreased by up to seven orders of magnitude by incorporation of metals to the film material. DLC covering may further effect an increase of the thermal conductivity near the tip apex and hence reduce tip heating effects. A fundamental advantage of field ion extraction from tips is that sputtering effects at the tip do not occur, whereas in field electron emitters the stability of the electron current is problematic due to ions accelerated towards the apex.

In order to produce a field-ionization source according to the invention, four wafer are fabricated and aligned with small tolerances (in the 25 nm range for sub-100 nm lithography). For this purpose a temperature-invariant kinematic mount is needed, and has to be combined with high precision (nm range) positioning elements to adjust the final alignment. As a small shift of the extraction electrodes with respect to the tip electrodes results basically in an overall deflection of all beams, appropriate precautions have to be taken against small rotational errors which may lead to significant distortions of the arrayed beam.

In a first production step, a highly regular array of tips is formed by etching a highly planar surface of a Si wafer, e.g. of 670 μm thickness, forming the tip electrodes of the field ion source. Semiconductor processing techniques available, as described for example by Ivo W. Rangelow et al., op. cit., can be applied.

The counter electrode means P2 is preferably produced from a commercial silicon on insulator wafer (SOI), which may consist of a SiO₂ layer buried between 670 μm thick silicon on one side, and 3 μm thick silicon on the other side of the SiO₂ layer. A convenient way to create small apertures in the SOI wafer is to etch at first broad (e.g. 25 μm) openings through the thick Si side down to the SiO₂ and then open the small apertures by an independent lithographic step from the other side. A mask matching technique or any high precision lithography is required to match the array of the tips with the locations of the extraction apertures. The thick silicon part imparts to the mask-like extraction electrode the mechanic stiffness necessary for mounting (e.g. horizontally) in a wafer chuck. The thin Si layer 320 (FIG. 3a) that faces the generated ion beam during operation may be coated with a metal, e.g. Pt, to increase conductivity and surface stability.

The second aperture plate P3 represents, together with P2, the condenser lens system of the ion source. The plate P3 comprises a lens array 343 to control the single beam divergence, and in consequence the brilliance of the beam array composed of the plurality of single beams. The electrodes of the lens array are arranged in a series along the optical axis of the respective single beams. It can also be used to adjust the focus of the imaging by applying a high voltage potential. For this purpose, the wafer chucks C3, C4 (see below) for positioning of the plates P3, P4 are designed in a way that the second and third aperture plate can be contacted with a high voltage separately from the silicon carrier. The fabrication process of the beam limiting aperture plate corresponds to the process described above.

The third aperture plate P4 comprises a final aperture electrode 344 which mainly serves as a beam limiting aperture plate As the electrostatic potential at P4 is equal or in the range of the potential at P3, wafer chuck C4 requires high voltage insulation similar than wafer chuck C3. The fabrication process of the beam limiting aperture plate corresponds to the process described above.

An especially suitable way to align the wafers P1-P4 constituting the source 1 according to the invention with the required 25 nm precision to each other is outlined schematically in FIG. 4. FIG. 4 shows two sectional views of the source 1, namely, FIG. 4a a top sectional view (corresponding to line E-E in FIG. 4b), and FIG. 4b a longitudinal sectional view along line D-D in FIG. 4a. Three silicon wafer chucks C1-C4 are mounted kinematically in a silicon carrier CR, formed as a tube; advantageously, all parts P1-P4, C1-C4, CR are made from the same silicon rod. The use of the same material helps to avoid distortions of the wafer chucks, and consequently of the structured wafers themselves. Fine positioning is achieved by longitudinal spacer elements 401 of controllable length, e.g. thermal actuator elements or piezo crystal elements. The lowest wafer chuck C1, designed to carry the tip electrode wafer P1, is connected by a kinematic mount with the silicon tube CR. Electrical insulation is effected by e.g. sapphire balls 402 and glass insulator spacers 403. The next wafer chuck C2 is designed to carry the extraction aperture plate P2, is mounted upside down, and is held kinematically by six spacer elements of controllable length (three horizontal and three vertical). The elements with adjustable length allow to set the position of the extraction wafer plate in all coordinates required to set up the alignment, and at the same time, to the correct distance of the tip plane to the focus plane. The precision of positioning is limited mainly by the stability of the linear elements, in case of thermal actuator elements in the low nm regime. The third wafer chuck C3 is designed to carry the aperture lens array plate P3, mounted kinematically in a like manner as the second wafer chuck. Since the field strength, and hence the focal strength of the aperture lens array is in general adjusted by the electro-static potential within the aperture beam array, the absolute distance of the beam limiting apertures from the lower electrode is not significant. Therefore only the possibility of horizontal positioning of the wafer chuck has been indicated in the schematic drawing of FIG. 4. The fourth wafer chuck C4 is designed to hold the beam limiting apertures P4 in alignment with the three other plates. To achieve optimum stability of the system with respect to small thermal fluctuations, wafer chuck C1 would also be held by six longitudinal spacer elements (not shown in FIG. 4).

As already mentioned above, as a supply system for the emitter space S1, the source gas is fed in through feeding openings 15 into the space between the wafer chucks C1 and C2 and from there by means of differential pumping towards the vacuum space 102 through openings 42 provided in the first chuck C1.

It should be noted that a wafer mounting system as shown in FIG. 4 is only one suitable way to achieve proper positioning of the source components to each other. In other embodiments, most of the adjustable elements, especially the horizontal positioning elements, may be integrated into the wafers by, e.g., MEMS technology.

In order to detect the degree of alignment it is in principle sufficient to analyze the emittance and current density of the emitted ion current. Of course, additional elements such as optical markers or a reference system on the wafer are convenient to control the alignment of the wafers dynamically. The curvature of the wafer due to its own weight is negligible compared to the curvature of the wafer as produced by semiconductor technology.

The positions of the openings in the counter electrode and the cover plate may be defined by using a mask matching that mask which was used to define the positions of the openings 62 in the counter plate. Alternatively, in order to define the positions of the openings in the cover plate a “self-imprint” scheme may be used. In this case, the field ionization sources are operated to emit electrons towards the layer which represents the cover plate precursor. Thus, by virtue of the electrons thus irradiated, the sources produce a self-image in the layer, which may, for instance, comprise a resist cover layer. The positions can then be made manifest by, for instance, resist development and/or a subsequent etch step in which the irradiated regions will be etched faster than the other regions not affected by electron bombardment.

Of the various advantages of the invention the following are in particular interesting:

The FIA according to the invention can be manufactured for large emitter densities; with known structuring techniques, densities of up to 250,000 point sources/cm2 seem to be feasible. Assuming realistic tip currents of 10 pA inside the accepted 10 mrad divergence half angle and a cell size of 50×50 μm2, an ion current density of 0.4 μA/cm2 of the composed beam can be generated. The virtual source size of the single beam—and by virtue of the excellent alignment the virtual source size of the plurality of the beams as well—is less than 100 nm.

As the effective field enhancement at the apex of the tip varies slowly with the tip potential, the time-averaged ion current can be adjusted by changing the tip potential in the range of tens of volts. Similarily, due to the narrow width in which ionization can occur, it is possible to use the tip voltage as a gate to switch all beams on and off at once, i.e. perform a beam blanking.

The unique functional and productional features of the invention promote a plenitude of possible applications, such as the production of integrated circuits, flat screen technology, broad ion beam sources and ion implantation devices.

For writing/structuring application there are two strategies to take advantage of the proposed field ionization array (FIA).

Firstly, a focused ion beam “parallel printer”, where the images of the virtual source of the tips (less than 100 nm) are imaged parallel in proximity to a substrate surface, for example to a wafer, where every single ion source operates as a miniaturized ion column, patterning a unit cell of a translationally symmetrical structure. Focusing is effected by appropriate distances the tip wafer and the aperture plate. The writing strategy will be scanning or rotating of all beams over the substrate by either moving the substrate using an XY-alignment table, or deflecting all beams simultaneously. Blanking of all beams at once can be achieved simply by shifting the tip electrode voltage or that of its counter electrode so that the field near the tip falls below the critical value and the ionization probability drops to zero. It is important to notice that the described blanking system has fundamental advantages to other, known particle beam blanking devices, as the image position on the wafer remains unchanged while blanking, and no sputter damage is effected at any part of the optical column.

The second application of the invention is a broad beam ion illumination system e.g. for ion projection technologies or ion implanters, in which the plurality of FIA beams is composed to one optical particle beam. In order to maximize the brightness of the composed beam, the phase space of all single beams has to be unified so that the composite particle beam gains maximum brightness. The composite beam of high brightness, consisting of discrete sub-beams aligned parallel and collimated, can be smeared by a “wobbler” without emittance loss in order to produce a homogeneous current density.

We claim:

1. A field-ionization source, comprising an array of emitter electrodes and counter electrode means positioned at a distance from the base of the emitter electrodes, the emitter electrodes extending within an emitter space from their respective bases towards said counter electrode means and ending in emitter tips, each of said tips located near to a corresponding opening formed in said counter electrode means, wherein
the field-ionization source further comprises a distribution system connectable to a supply for a source substance and being adapted to distribute said source substance towards the emitter tips in the emitter space,
the emitter electrodes are adapted to be connected to a positive electric high voltage of at least 2 kV with respect to the corresponding counter electrode means, and
the emitter tips are adapted to ionize gas species provided from the source substance by means of said high voltage and accelerate ions thus produced through said corresponding openings in said counter electrode means.

1. The field-ionization source of claim 1, wherein the emitter electrodes are arranged in a two-dimensional periodic arrangement and the counter electrode means comprises a two-dimensional arrangement of openings corresponding to said emitter electrode array, said two arrangements surrounding the emitter space of the emitter electrodes.

2. The field-ionization source of claim 1, wherein said two-dimensional periodic arrangements are arrays positioned parallel to each other.

3. The field-ionization source of claim 2, wherein said two-dimensional periodic arrangements are planar arrays.

4. The field-ionization source of claim 2, wherein said two-dimensional periodic arrangements are curved arrays having concentric curvatures.

5. The field-ionization source of claim 1, wherein at least the tips of the emitter electrodes consist of non-metallic material, including material from the group of semiconductors.

6. The field-ionization source of claim 1, wherein the emitter electrodes comprise a cover layer of chemically inert material having an electronic structure suitable for field ionization.

7. The field-ionization source of claim 1, wherein the distribution system is adapted to be operated by means of differential pumping of a gas used as source substance from the supply through the emitter space towards a pumped-off space.

8. The field-ionization source of claim 1, wherein the emitter space, including the emitter electrodes, is adapted to be cooled by a cryogenic liquid.

9. The field-ionization source of claim 8, wherein the cooling of the emitter space is done by means of the source substance being supplied as coolant.

10. The field-ionization source of claim 1, wherein the base of the emitter electrodes is separated from the counter electrode means by a vacuum gap.

11. The field-ionization source of claim 10, comprising a wafer chuck system adapted to precisely hold and position the emitter electrode array and the counter electrode means.

12. The field-ionization source of claim 1, wherein the apertures of the counter electrode means form a multi-beam electrostatic lens arrangement.
